(19) United States
(12) Patent Application Publication
(10) Pub. No.: US 2025/0297556 A1
(43) Pub. Date: Sep. 25, 2025

(54) AIRCRAFT POWERPLANT WITH JOINT SHIELD

(71) Applicant: Pratt & Whitney Canada Corp., Longueuil (CA)

(72) Inventors: Mateusz Ozog, Hucisko (PL); Maryam Shafiei Alavijeh, Mississauga (CA)

(21) Appl. No.: 18/609,824

(22) Filed: Mar. 19, 2024

(51) Int. Cl. F01D 25/24; F02C 7/00; F23R 3/00

(52) U.S. Cl. CPC F01D 25/243; F02C 7/00; F23R 3/002; F05D 2260/31

(57) ABSTRACT

An assembly is provided for an aircraft propulsion system. This assembly includes an outer wall structure and an inner wall structure. The outer wall structure extends axially along and circumferentially about an axis. The outer wall structure forms an outer peripheral boundary of a flowpath. The inner wall structure extends axially along and circumferentially about the axis. The inner wall structure is spaced radially in from the outer wall structure. The inner wall structure includes a first case, a second case and a shield. The first case forms a first section of an inner peripheral boundary of the flowpath. The second case is attached to the first case at a joint. The shield covers the joint and is arranged radially between the joint and the flowpath.

### TECHNICAL FIELD

This disclosure relates generally to an aircraft and, more particularly, to a flowpath wall for an aircraft powerplant.

### BACKGROUND INFORMATION

An aircraft powerplant may include various internal flowpaths. Each flowpath may be formed by one or more wall structures. Various types and configurations of wall structures are known in the art. While these known wall structures have various benefits, there is still room in the art form improvement.

### SUMMARY

According to an aspect of the present disclosure, an assembly is provided for an aircraft propulsion system. This assembly includes an outer wall structure and an inner wall structure. The outer wall structure extends axially along and circumferentially about an axis. The outer wall structure forms an outer peripheral boundary of a flowpath. The inner wall structure extends axially along and circumferentially about the axis. The inner wall structure is spaced radially in from the outer wall structure. The inner wall structure includes a first case, a second case and a shield. The first case forms a first section of an inner peripheral boundary of the flowpath. The second case is attached to the first case at a joint. The shield covers the joint and is arranged radially between the joint and the flowpath.

According to another aspect of the present disclosure, another assembly is provided for an aircraft propulsion system. This assembly includes a powerplant core and a wall structure. The powerplant core includes a compressor section, a combustor section and a turbine section. The wall structure is radially outboard of, extends along and circumscribes the powerplant core. The wall structure includes a first case, a second case and a shield. The second case is attached to the first case at a bolted flange connection between the first case and the second case. The shield is radially outboard of and covers the bolted flange connection. The shield is attached to the first case and the second case through the bolted flange connection.

According to still another aspect of the present disclosure, another assembly is provided for an aircraft propulsion system. This assembly includes a combustor and a wall structure. The combustor is disposed in a diffuser plenum. The wall structure is outboard of the combustor and forms an outer peripheral boundary of the diffuser plenum. The wall structure includes a first case, a second case and a shield outside of the diffuser plenum. The first case includes a first case wall and a first case flange that projects out from the first case wall. The second case includes a second case wall and a second case flange that projects out from the second case wall. The second case flange is bolted to the first case flange at a bolted connection. The shield extends along and circumferentially around the bolted connection. The shield is attached to the first case and the second case through the bolted connection.

The first case may form a first section of an inner peripheral boundary of a flowpath. The shield may form a second section of the inner peripheral boundary of the flowpath that extends axially out from the first section.

The joint may be a bolted flange connection between the first case and the second case.

The first case may include a first case wall and a first case flange projecting radially outward from the first case wall at an axial first end of the first case. The second case may include a second case wall and a second case flange projecting radially outward from the second case wall at an axial second end of the second case. The first case flange may be mechanically fastened to the second case flange at the joint.

The shield may include a shield wall and a shield flange. The shield wall may axially and circumferentially cover the first case flange and the second case flange. The shield flange may project radially inward from the shield wall. The shield flange may be mechanically fastened to the first case flange and/or the second case flange.

The inner wall structure may also include a plurality of mechanical fasteners. Each of the mechanical fasteners may project axially through the first case flange, the second case flange and the shield flange.

The shield wall may be configured with a plurality of ports. Each of the ports may be open and aligned with a respective one of the mechanical fasteners.

The first case may be upstream of the second case along the flowpath. The first case flange may be between the second case flange and the shield flange.

The first case may be upstream of the second case along the flowpath. The second case flange may be between the first case flange and the shield flange.

The shield may form a second section of the inner peripheral boundary of the flowpath located next to and downstream of the first section.

The second section may have a straight line sectional geometry at least a portion of along a length of the shield.

The second section may have a convex sectional geometry along at least a portion of a length of the shield.

The first case may be upstream of the second case along the flowpath. The second section may taper radially inward as the shield extends axially towards the first case.

The shield may be configured from or otherwise include a ceramic material.

The shield may be configured from or otherwise include a metal material.

The shield may be configured from or otherwise include a composite material.

The assembly may also include a powerplant core. The flowpath may be disposed radially outboard of the powerplant core.

The assembly may also include a combustor disposed within a diffuser plenum. The first case and/or the second case may form an outer peripheral boundary of the diffuser plenum.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial schematic illustration of an aircraft powerplant.

FIG. 2 is a sectional illustration of a portion of the aircraft powerplant at a covered joint in an inner wall structure.

FIGS. 3-5 are sectional illustrations of respective portions of the aircraft powerplant at the covered joint with various alternative configurations.

### DETAILED DESCRIPTION

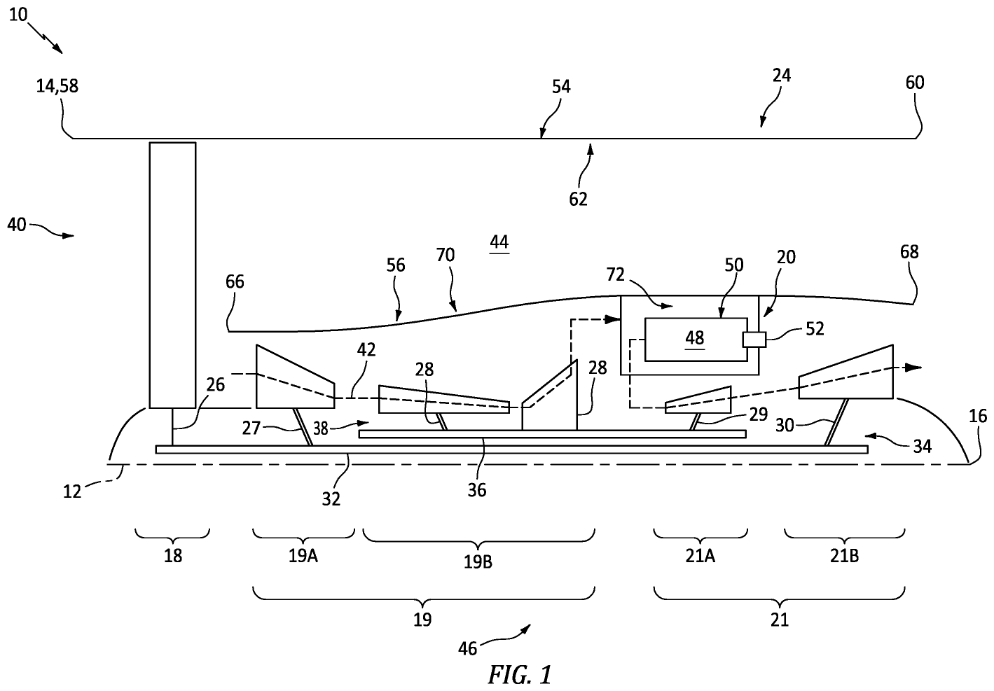

FIG. 1 illustrates a powerplant 10 for an aircraft. The aircraft may be an airplane, a drone (e.g., an unmanned aerial vehicle (UAV)) or any other manned or unmanned aerial vehicle or system. The aircraft powerplant 10 may be configured as, or included as part of, a propulsion system for the aircraft. The aircraft powerplant 10 may also or alternatively be configured as, or included as part of, an electrical power system for the aircraft. However, for ease of description, the aircraft powerplant 10 is described below as the aircraft propulsion system.

The aircraft powerplant 10 extends axially along an axis 12 between an upstream, forward end 14 of the aircraft powerplant 10 and a downstream, aft end 16 of the aircraft powerplant 10. Briefly, the axis 12 may be a centerline axis of the aircraft powerplant 10 and/or one or more of its structures and/or components. The axis 12 may also or alternatively be a rotational axis of one or more structures and/or components of the aircraft powerplant 10.

The aircraft powerplant 10 may be configured as or otherwise include a turbofan gas turbine engine. The aircraft powerplant 10 of FIG. 1, for example, includes a fan section 18, a compressor section 19, a combustor section 20 and a turbine section 21. The compressor section 19 of FIG. 1 includes a low pressure compressor (LPC) section 19A and a high pressure compressor (HPC) section 19B. The turbine section 21 of FIG. 1 includes a high pressure turbine (HPT) section 21A and a low pressure turbine (LPT) section 21B. These propulsion system sections 18, 19A, 19B, 20, 21A and 21B are arranged within a powerplant housing 24; e.g., an engine housing.

Each of the powerplant sections 18, 19A, 19B, 21A and 21B includes a respective bladed rotor 26-30. Each of these bladed rotors 26-30 includes a plurality of rotor blades (e.g., airfoils, vanes, etc.) and one or more rotor bases (e.g., disks, hubs, etc.). The rotor blades are arranged circumferentially around the respective rotor base(s) in one or more arrays. Each rotor blade is connected to and projects out from the respective rotor base.

The fan rotor 26 and the LPC rotor 27 are coupled to and rotatable with the LPT rotor 30. The fan rotor 26 and the LPC rotor 27 of FIG. 1, for example, are connected to the LPT rotor 30 through a low speed shaft 32. At least (or only) the fan rotor 26, the LPC rotor 27, the LPT rotor 30 and the low speed shaft 32 may collectively form a low speed rotating assembly 34; e.g., a low speed spool of the aircraft powerplant 10. Similarly, the HPC rotor 28 is coupled to and rotatable with the HPT rotor 29. The HPC rotor 28 of FIG. 1, for example, is connected to the HPT rotor 29 through a high speed shaft 36. At least (or only) the HPC rotor 28, the HPT rotor 29 and the high speed shaft 36 may collectively form a high speed rotating assembly 38; e.g., a high speed spool of the aircraft powerplant 10. The rotating assemblies 34 and 38 are rotatably supported by a plurality of bearings (not shown). Each of these bearings is connected to the powerplant housing 24 by at least one stationary structure such as, for example, an annular support frame. Each of the rotating assemblies 34, 38 may thereby be rotatable about the axis 12 within the powerplant housing 24.

During operation, ambient air enters the aircraft powerplant 10 through an airflow inlet 40 at the powerplant forward end 14. This air is directed through the fan section 18 and into a (e.g., annular) core flowpath 42 and a (e.g., annular) bypass flowpath 44. The core flowpath 42 extends sequentially through the powerplant sections 19A, 19B, 20, 21A and 21B; e.g., a core 46 and/or gas generator of the aircraft powerplant 10. The air within the core flowpath 42 may be referred to as “core air”. The bypass flowpath 44 extends through a bypass duct that bypasses (e.g., is radially outboard of and extends axially along) the powerplant core 46. The air within the bypass flowpath 44 may be referred to as “bypass air”.

The core air is compressed by the LPC rotor 27 and the HPC rotor 28 and directed into a (e.g., annular) combustion chamber 48 of a (e.g., annular) combustor 50 in the combustor section 20. Fuel is injected into the combustion chamber 48 by one or more fuel injectors 52 (one visible in FIG. 1) and the fuel is mixed with the compressed core air to provide a fuel-air mixture. This fuel-air mixture is ignited and combustion products thereof flow through and sequentially drive rotation of the HPT rotor 29 and the LPT rotor 30. The rotation of the HPT rotor 29 and the LPT rotor 30 respectively drive rotation of the HPC rotor 28 and the LPC rotor 27 and, thus, compression of the air received from an inlet into the core flowpath 42. The rotation of the LPT rotor 30 also drives rotation of the fan rotor 26. The rotation of the fan rotor 26 propels the bypass air through and out of the bypass flowpath 44. The propulsion of the bypass air may account for a majority of thrust generated by the aircraft powerplant 10.

The powerplant housing 24 of FIG. 1 includes a radial outer wall structure 54 and a radial inner wall structure 56. The outer wall structure 54 extends axially along the axis 12 from an upstream, forward end 58 of the outer wall structure 54 to a downstream, aft end 60 of the outer wall structure 54. Here, the outer wall structure forward end 58 is also the powerplant forward end 14. The outer wall structure aft end 60 is disposed proximate, but may be axially recessed forward from, the powerplant aft end 16. The outer wall structure 54 is spaced radially outboard from the fan rotor 26 and the inner wall structure 56. The outer wall structure 54 extends circumferentially about (e.g., circumscribes) the axis 12, the fan rotor 26, the powerplant core 46 and the inner wall structure 56. With this arrangement, an axial forward section of the outer wall structure 54 forms a fan case for and houses the fan rotor 26. An axial aft section of the outer wall structure 54 forms a (e.g., tubular) radial outer peripheral boundary 62 of the bypass flowpath 44 within the aircraft powerplant 10.

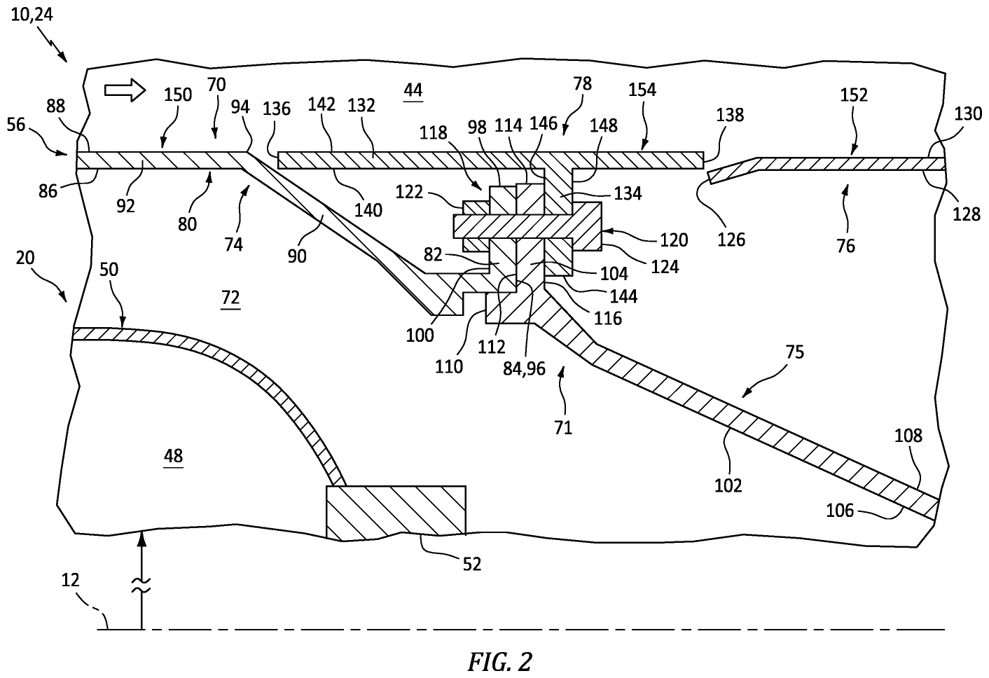

The inner wall structure 56 extends axially along the axis 12 from an upstream, forward end 66 of the inner wall structure 56 to a downstream, aft end 68 of the inner wall structure 56. Here, the inner wall structure forward end 66 is disposed downstream, aft of and may be next to (e.g., adjacent) the fan rotor 26. The inner wall structure aft end 68 is disposed proximate, but may be axially recessed forward from, the powerplant aft end 16. Note, while the inner wall structure aft end 68 of FIG. 1 is axially aligned with the outer wall structure aft end 60, the present disclosure is not limited to such an exemplary arrangement. The inner wall structure 56 is spaced radially outboard of the LPC rotor 27, the HPC rotor 28, the combustor 50, the HPT rotor 29 and the LPT rotor 30. The inner wall structure 56 extends circumferentially about (e.g., circumscribes) the axis 12 and the powerplant members 27-30 and 50. With this arrangement, the inner wall structure 56 may form a casing structure for and house the powerplant members 27-30 and 50. The inner wall structure 56 forms a (e.g., tubular) radial inner peripheral boundary 70 of the bypass flowpath 44 within the aircraft powerplant 10 that is radially opposite the outer peripheral boundary 62 of the bypass flowpath 44. Referring to FIG. 2, the inner wall structure 56 may also form a (e.g., tubular) radial outer peripheral boundary 71 of a (e.g., annular) diffuser plenum 72 along the core flowpath 42. Here, the combustor 50 is disposed (or projects into) in the diffuser plenum 72, and the diffuser plenum 72 supplies the compressed core air for introduction into the combustion chamber 48.

The inner wall structure 56 of FIG. 2 includes one or more powerplant cases 74-76 and a joint shield 78; e.g., a flowpath baffle. The forward case 74 of FIG. 2 includes a forward case wall 80 (“forward wall”) and a forward case flange 82 (“forward flange”). The forward wall 80 extends axially along the axis 12 to an axial aft end 84 of the forward case 74. The forward wall 80 extends radially between and to a radial inner side 86 of the forward case 74 and its forward wall 80 and a radial outer side 88 of the forward wall 80. The forward wall 80 extends circumferentially about (e.g., completely around) the axis 12 providing this forward wall 80 with, for example, a full-hoop (e.g., tubular) geometry. An axial aft section 90 of the forward wall 80 of FIG. 2 radially tapers inwards (e.g., towards the axis 12) as that aft section 90 of the forward wall 80 extends axially from an axial forward section 92 of the forward wall 80 towards (e.g., to or about) the forward case aft end 84. The forward wall 80 at (e.g., on, adjacent or proximate) the forward case aft end 84 is thereby radially recessed inward from the forward wall 80 along the forward section 92 of the forward wall 80/at an intersection 94 between the forward wall sections 90 and 92.

The forward flange 82 is disposed at the forward case aft end 84. An axial side 96 of the forward flange 82 of FIG. 2, for example, may partially form the forward case aft end 84. The forward flange 82 is connected to (e.g., formed integral with or otherwise attached to) the forward wall 80 and its aft section 90. The forward flange 82 of FIG. 2 projects radially out (outward away from the axis 12) from the aft section 90 of the forward wall 80 at the forward wall outer side 88 to a distal radial outer end 98 of the forward flange 82. This forward flange 82 extends axially along the axis 12 between opposing axial sides 96 and 100 of the forward flange 82. The forward flange 82 extends circumferentially about (e.g., completely around) the axis 12 providing this forward flange 82 with, for example, a full-hoop (e.g., annular) geometry.

The aft-inner case 75 of FIG. 2 includes an aft-inner case wall 102 (“inner wall”) and an aft-inner case flange 104 (“inner flange”). The inner wall 102 extends axially along the axis 12 to an axial forward end 110 of the aft-inner case 75. The inner wall 102 extends radially between and to a radial inner side 106 of the aft-inner case 75 and its inner wall 102 and a radial outer side 108 of the inner wall 102. The inner wall 102 extends circumferentially about (e.g., completely around) the axis 12 providing this inner wall 102 with, for example, a full-hoop (e.g., tubular) geometry. At least an axial forward section of the inner wall 102 of FIG. 2 radially expands outwards (e.g., away from the axis 12) as that forward section of the inner wall 102 extends axially towards (e.g., to or about) the aft-inner case forward end 110.

The inner flange 104 is disposed at the aft-inner case forward end 110. An axial side 112 of the inner flange 104 of FIG. 2, for example, is (e.g., slightly) recessed from the aft-inner case forward end 110. The inner flange 104 is connected to (e.g., formed integral with or otherwise attached to) the inner wall 102 and its forward section. The inner flange 104 of FIG. 2 projects radially out (outward away from the axis 12) from the forward section of the inner wall 102 at the aft-inner wall outer side 108 to a distal radial outer end 114 of the inner flange 104. This inner flange 104 extends axially along the axis 12 between opposing axial sides 112 and 116 of the inner flange 104. The inner flange 104 extends circumferentially about (e.g., completely around) the axis 12 providing this inner flange 104 with, for example, a full-hoop (e.g., annular) geometry.

The aft-inner case 75 is attached to the forward case 74 at a joint 118 between the forward case 74 and the aft-inner case 75. This joint 118 may be a bolt-flange joint, or alternatively another type of mechanical inter-case connection/splice. The side 112 of the inner flange 104 of FIG. 2, for example, is disposed axially next to and engages (e.g., abuts against, contacts, etc.) the side 96 of the forward flange 82. A plurality of fasteners 120 (e.g., bolts) (one visible in FIG. 2) are arranged circumferentially about the axis 12 in an annular array; e.g., a circular array. Each of the fasteners 120 of FIG. 2 projects through the inner flange 104 and the forward flange 82 and is mated with a respective nut 122. The inner flange 104 and the forward flange 82 may thereby be bolted together; e.g., axially clamped between a head 124 of each fastener 120 and the respective nut 122.

The aft-outer case 76 of FIG. 2 extends axially along the axis 12 to an axial forward end 126 of the aft-outer case 76. This aft-outer case forward end 126 may be disposed proximate, but aft of the joint 118 along the axis 12 and downstream of the joint 118 along the bypass flowpath 44. The aft-outer case 76 extends radially between and to a radial inner side 128 of the aft-outer case 76 and a radial outer side 130 of the aft-outer case 76. The aft-outer case 76 extends circumferentially about (e.g., completely around) the axis 12 providing this aft-outer case 76 with, for example, a full-hoop (e.g., tubular) geometry. The aft-outer case 76 is disposed radially outboard of the aft-inner case 75. The aft-outer case 76 of FIG. 2 may thereby axially overlap and circumscribe the aft-inner case 75 aft and downstream of the joint 118.

The joint shield 78 is configured to cover the joint 118 along the bypass flowpath 44. The joint shield 78, for example, is configured to form a baffle between the bypass air flowing through the bypass flowpath 44 and the joint 118. The joint shield 78 of FIG. 2 includes a shield wall 132 and a shield flange 134.

The shield wall 132 extends axially along the axis 12 from an axial forward end 136 of the joint shield 78 and its shield wall 132 to an axial aft end 138 of the joint shield 78 and its shield wall 132. The shield wall 132 extends radially between and to a radial inner side 140 of the shield wall 132 and a radial outer side 142 of the joint shield 78 and its shield wall 132. The shield wall 132 extends circumferentially about (e.g., completely around) the axis 12 providing the shield wall 132 with, for example, a full-hoop (e.g., tubular) geometry.

The shield flange 134 of FIG. 2 is disposed at an intermediate location between the shield forward end 136 and the shield aft end 138. The shield flange 134 of FIG. 2, for example, is located (e.g., slightly) axially aft of center between the shield forward end 136 and the shield aft end 138. It is contemplated, however, the shield flange 134 may alternatively be located (e.g., slightly) axially forward of center, or centered, between the shield forward end 136 and the shield aft end 138. The shield flange 134 is connected to (e.g., formed integral with or otherwise attached to) the shield wall 132. The shield flange 134 of FIG. 2 projects radially out (inward towards the axis 12) from the shield wall 132 at the intermediate location to a distal radial inner end 144 of the shield flange 134. This shield flange 134 extends axially along the axis 12 between opposing axial sides 146 and 148 of the shield flange 134. The shield flange 134 extends circumferentially about (e.g., completely around) the axis 12 providing this shield flange 134 with, for example, a full-hoop (e.g., annular) geometry.

The joint shield 78 is attached to the forward case 74 and/or the aft-inner case 75 at the joint 118. The side 146 of the shield flange 134 of FIG. 2, for example, is disposed axially next to and engages (e.g., abuts against, contacts, etc.) the side 96 of the inner flange 104. The inner flange 104 of FIG. 2 is thereby disposed and clamped axially between the forward flange 82 and the shield flange 134. Each fastener 120 of FIG. 2, for example, projects through the shield flange 134 in addition to the other joint flanges 104 and 82, where the flanges 134, 104 and 82 are axially clamped sequentially between each fastener head 124 and the respective nut 122. It is contemplated, however, the joint shield 78 may alternatively be otherwise attached to one or more members of the inner wall structure 56.

The joint shield 78 of FIG. 2 extends axially across and may substantially (or partially) bridge an axial gap between the forward case 74 and its forward wall 80 and the aft-outer case 76. The shield forward end 136 of FIG. 2, for example, is disposed axially next to and may be (e.g., slightly) spaced axially aft and downstream from the intersection 94 between the forward wall sections 90 and 92. Here, the shield wall 132 at the shield forward end 136 may be radially aligned with (e.g., flush with) or (e.g., slightly) radially recessed from the forward section 92 of the forward wall 80 at the intersection 94 between the forward wall sections 90 and 92. The shield aft end 138 of FIG. 2 is disposed axially next to and may be (e.g., slightly) spaced axially forward and upstream from the aft-outer case 76 at its aft-outer case forward end 126. Here, the shield wall 132 at the shield aft end 138 may be radially aligned with (e.g., flush with) or (e.g., slightly) radially outboard from the aft-outer case 76 at its aft-outer case forward end 126.

With the foregoing arrangement, the forward case 74, the aft-outer case 76 and the joint shield 78 may collectively form at least a portion (or an entirety) of the inner peripheral boundary 70 of the bypass flowpath 44. The forward case 74 and its forward section 92 of the forward wall 80 of FIG. 2, for example, form a forward section 150 of the inner peripheral boundary 70 of the bypass flowpath 44. The aft-outer case 76 forms an aft section 152 of the inner peripheral boundary 70 of the bypass flowpath 44. The joint shield 78 and its shield wall 132 form an intermediate section 154 of the inner peripheral boundary 70 of the bypass flowpath 44. This boundary intermediate section 154 extends axially between and may substantially bridge the axial gap between a downstream, aft end of the boundary forward section 150 and an upstream, forward end of the boundary aft section 152. The joint shield 78 may thereby maintain an air gap between the joint 118 and the bypass air flowing through the bypass flowpath 44. The joint shield 78 may also or alternatively deflect the bypass air flowing through the bypass flowpath 44 away from the joint 118. The joint 118 therefore is not (e.g., at least directly) exposed to the bypass air flowing within the bypass flowpath 44. Moreover, since the joint shield 78 covers the joint 118, the bypass air is reflected and heat transfer may be significantly decreased within the protected cavity surrounding the joint 118.

Reducing or eliminating the exposure of the bypass air to the joint 118 may reduce a thermal gradient across the joint 118. For example, with the arrangement of FIG. 2, the forward wall 80 and the inner wall 102 are exposed to the relatively warm compressed core air within the diffuser plenum 72. Heat energy from the core air may transfer into the forward wall 80 and the inner wall 102, and some of this heat energy may then transfer into (via conduction) the flanges 82 and 104. The members of the inner wall structure 56 along the inner peripheral boundary 70 of the bypass flowpath 44, on the other hand, are exposed to the relatively cool bypass air within the bypass flowpath 44. Without the joint shield 78 of FIG. 2, the ends of the unshielded flanges may be (e.g., rapidly) cooled by the bypass air. The unshielded flanges may thereby be subject to a relatively large thermal gradient which increases thermally induces stresses within the joint. The joint shield 78, however, provides a buffer between the joint 118 and the relatively cool bypass air.

In some embodiments, each of the inner wall structure members 74-76 and 78 may be constructed from a metal material; e.g., pure metal, a metal alloy, etc. In other embodiments, the joint shield 78 may alternatively be constructure from a ceramic material (e.g., a monolithic ceramic, a ceramic matrix composite (CMC), etc.) or another relatively low thermally conductive material such as a composite material (e.g., a fiber-reinforced composite material). In such embodiments, the material of the joint shield 78 may be selected to thermally insulate the joint 118 from the bypass air.

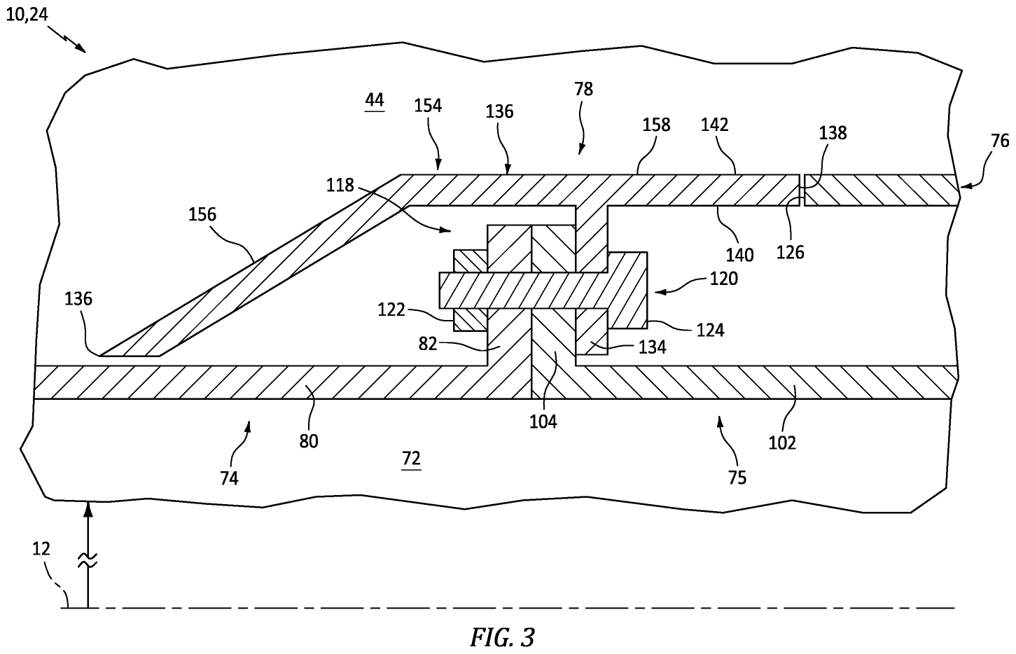

In some embodiments, referring to FIG. 2, at least a portion or an entirety of the boundary intermediate section 154 may have a straight line sectional geometry when viewed, for example, in a reference plane parallel with (e.g., including) the axis 12. Here, the shield outer side 142 forms a cylindrical flowpath surface where a radius from the axis 12 to the shield outer side 142 may remain uniform (e.g., constant) as the shield wall 132 extends axially between the shield ends 136 and 138. In other embodiments, referring to FIG. 3, at least a portion or an entirety of the boundary intermediate section 154 may have a (e.g., generally) convex and/or tapered sectional geometry when viewed, for example, in the reference plane. The boundary intermediate section 154 of FIG. 3, for example, radially tapers (towards the axis 12) as an axial forward section 156 of the shield wall 132 extends axially from an axial aft section 158 of the shield wall 132 to (or towards) the shield forward end 136. The forward section 156 of the shield wall 132 may form a frustoconical flowpath surface. The aft section 158 of the shield wall 132, on the other hand, may form a cylindrical flowpath surface, or a curved surface with a reduced slope along the axis 12.

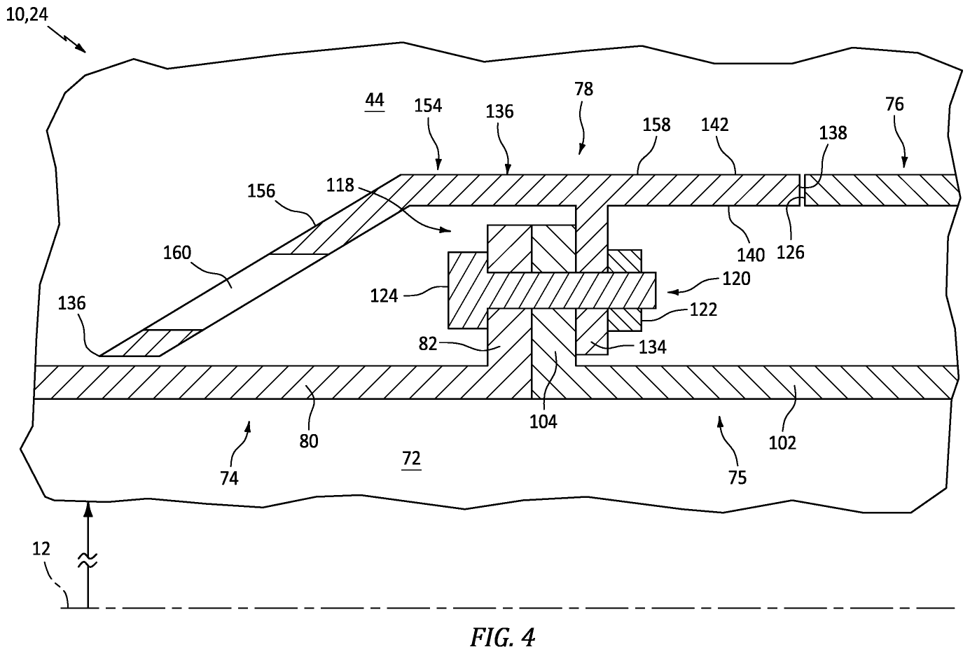

In some embodiments, referring to FIGS. 2 and 3, the shield wall 132 may be axially and/or circumferentially uninterrupted. In other embodiments, referring to FIG. 4, the shield wall 132 may be configured with one or more (e.g., open, empty) ports 160. Each of these ports 160 extends (e.g., axially) through the shield wall 132 and may be (e.g., radially and/or circumferentially) aligned with a respective one of the fasteners 120. Each port 160 may thereby provide access to the respective fastener 120 for installation of the joint shield 78 and/or assembly of the joint 118.

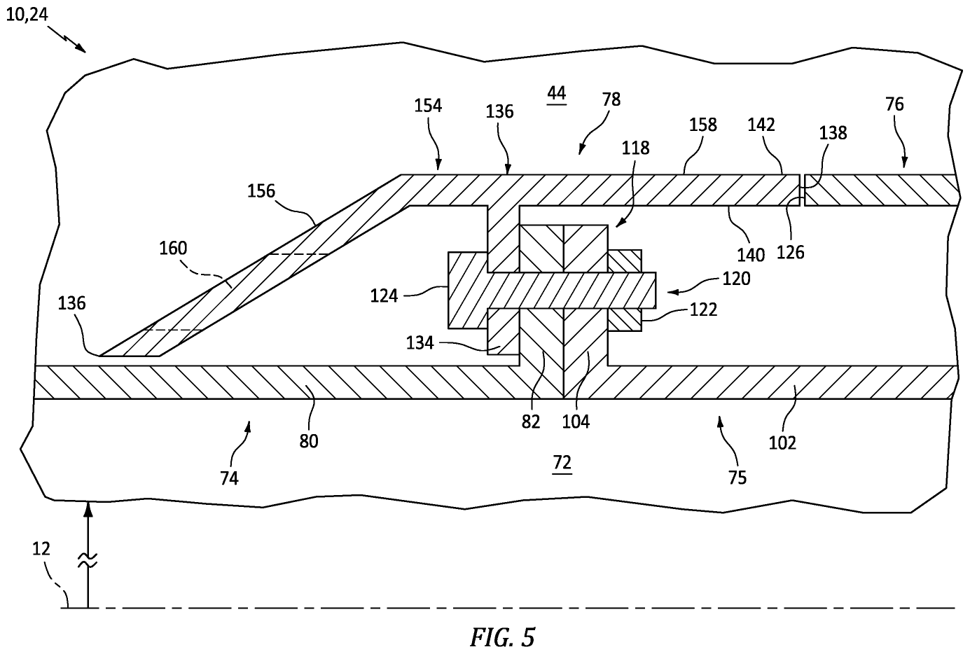

In some embodiments, referring to FIGS. 2 and 3, the shield flange 134 may be disposed downstream, axially aft of the flanges 82 and 104 at the joint 118. In other embodiments, referring to FIG. 5, the shield flange 134 may be disposed upstream, axially forward of the flanges 82 and 104 at the joint 118. In still other embodiments, it is contemplated the shield flange 134 may alternatively be arranged axially between the flanges 82 and 104 at the joint 118.

While the joint shield 78 is shown at a joint adjacent and radially outboard of the diffuser plenum 72 in FIG. 2, the present disclosure is not limited to such an exemplary arrangement. The joint shield 78, for example, may alternatively be arranged with and cover another joint upstream or downstream of the joint 118 of FIG. 2. In another example, the joint shield 78 may be configured to cover a joint along the outer wall structure 54. While the joint shield 78 is described above as shielding a joint along the bypass flowpath 44, it is contemplated the joint shield 78 may alternatively cover a joint along another (e.g., annular) flowpath within the aircraft powerplant 10; e.g., a cooling flowpath, a third stream flowpath, etc. Moreover, while the aircraft powerplant 10 is described above as a turbofan gas turbine engine, it is contemplated the joint shield 78 may also be included in various other types of aircraft powerplants. Examples of these other aircraft powerplants include, but are not limited to, a turbojet gas turbine engine, a turboshaft gas turbine engine and a turboprop gas turbine engine. In some embodiments, the turbine engine may be a direct drive turbine engine. In other embodiments, the turbine engine may be a geared turbine engine with a geartrain (e.g., an epicyclic gear system) between a turbine rotor and a drive rotor; e.g., a fan rotor and/or a compressor rotor. The present disclosure therefore is not limited to any particular types or configurations of aircraft powerplants.

In some embodiments, the joint shield 78 may be configured as an uninterrupted full-hoop (e.g., annular) body. In other embodiments, the joint shield 78 may be configured as a segmented body. The joint shield 78, for example, may include a plurality of (e.g., arcuate) segments which are arranged circumferentially end-to-end to collectively provide the joint shield 78 with a segmented full-hoop body.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

1. An assembly for an aircraft propulsion system, comprising:
an outer wall structure extending axially along and circumferentially about an axis, the outer wall structure forming an outer peripheral boundary of a bypass flowpath; and
an inner wall structure extending axially along and circumferentially about the axis, the inner wall structure spaced radially in from the outer wall structure, and the inner wall structure including a first case, a second case and a shield;
the first case forming a first section of an inner peripheral boundary of the bypass flowpath;
the second case attached to the first case at a joint; and
the shield covering the joint and arranged radially between the joint and the bypass flowpath,
wherein the first case includes a first case wall and a first case flange projecting radially outward from the first case wall at an axial end of the first case,
wherein the second case includes a second case wall and a second case flange projecting radially outward from the second case wall at an axial end of the second case,
wherein the shield includes a shield wall and a shield flange projecting radially inward from the shield wall, and the shield flange is mechanically fastened to the first case flange and the second case flange at the joint, and
wherein the shield wall axially and circumferentially covers the first case flange, the second case flange, an axially aft section of the first case wall, and an axially forward section of the second case wall.

2. The assembly of claim 1, wherein the joint is a bolted flange connection between the first case and the second case.

3. (canceled)

4. (canceled)

5. The assembly of claim 1, wherein the inner wall structure further includes a plurality of mechanical fasteners, and each of the plurality of mechanical fasteners projects axially through the first case flange, the second case flange and the shield flange.

6. The assembly of claim 5, wherein
the shield wall is configured with a plurality of ports; and
each of the plurality of ports is open and aligned with a respective one of the plurality of mechanical fasteners.

7. The assembly of claim 1, wherein
the first case is upstream of the second case along the bypass flowpath; and
the first case flange is between the second case flange and the shield flange.

8. The assembly of claim 1, wherein
the first case is upstream of the second case along the bypass flowpath; and
the second case flange is between the first case flange and the shield flange.

9. The assembly of claim 1, wherein the shield forms a second section of the inner peripheral boundary of the bypass flowpath located next to and downstream of the first section.

10. The assembly of claim 9, wherein the second section has a straight line sectional geometry along at least a portion of a length of the shield.

11. The assembly of claim 9, wherein the second section has a convex sectional geometry along at least a portion of a length of the shield.

12. The assembly of claim 9, wherein
the first case is upstream of the second case along the bypass flowpath; and
the second section tapers radially inward as the shield extends axially towards the first case.

13. The assembly of claim 1, wherein the shield comprises a ceramic material.

14. The assembly of claim 1, wherein the shield comprises a metal material.

15. The assembly of claim 1, wherein the shield comprises a composite material.

16. The assembly of claim 1, further comprising:
a powerplant core;
the bypass flowpath disposed radially outboard of the powerplant core.

17. (canceled)

18. The assembly of claim 1, further comprising:
a combustor disposed within a diffuser plenum;
at least one of the first case or the second case forming an outer peripheral boundary of the diffuser plenum.

19. An assembly for an aircraft propulsion system, comprising:
a powerplant core including a compressor section, a combustor section and a turbine section; and
a wall structure radially outboard of, extending along and circumscribing the powerplant core, the wall structure including a first case, a second case and a shield;
the second case attached to the first case at a bolted flange connection between the first case and the second case; and
the shield radially outboard of and covering the bolted flange connection, and the shield attached to the first case and the second case through the bolted flange connection.

20. An assembly for an aircraft propulsion system, comprising:
a combustor disposed in a diffuser plenum; and
a wall structure outboard of the combustor and forming an outer peripheral boundary of the diffuser plenum, the wall structure including a first case, a second case and a shield outside of the diffuser plenum;
the first case including a first case wall and a first case flange that projects out from the first case wall;
the second case including a second case wall and a second case flange that projects out from the second case wall, the second case flange bolted to the first case flange at a bolted connection; and
the shield extending along and circumferentially around the bolted connection, and the shield attached to the first case and the second case through the bolted connection.
